(19) United States
(12) Patent Application Publication
(10) Pub. No.: US 2008/0185846 A1
(43) Pub. Date: Aug. 7, 2008

(54) Electrolytic inductive self-boosting technology

(76) Inventor: Bereli M. Lazar, San Francisco, CA (US)

Correspondence Address: Bereli M. Lazar, Apt. #410S, 1590 Broadway St., San Francisco, CA, 94109, US

(21) Appl. No.: 11/701,340

(22) Filed: Feb. 2, 2007

(51) Int. Cl. F02B 63/04

(52) U.S. Cl. 290/1 R

(57) ABSTRACT

The electrolytic inductive self-boosting technology comprises a system of electro-machines including generators, alternators, independent rotor free integrators and motors. Any of said electro-machines include:
A closed loop tubular tunnel filled-in with fluid electrolyte which is propelled by rotary impeller, and
A magnet structure for inductive operating with the driven electrolyte as a fluid ionic electroconductor, and
Electric and mechanical infrastructures.
   Said impeller driving the electrolyte, works in actual series with itself, for itself, and at itself thus providing high potential fluid flow for better inductance and constant energy integration in self-boosting manner.

The structure comprises various rotor-magnetic and rotor-free generators, integrators and alternators, including combined inductive hydrodynamic turbo-sets; torque-speed adjustable motors; multi-tunnel schemes with cascade arrangements. The power ratio is about 2.3 depending on design, KW required and voltage, and providing to proposed electrolytic dynamic technology operative flexibility and high efficiency.

### CROSS-REFERENCE TO RELATED APPLICATIONS

Not Applicable.

### FEDERALLY SPONSORED RESEARCH

Not Applicable.

### SEQUENCE LISTING OR PROGRAM

Not Applicable.

### BACKGROUND OF THE INVENTION

This proposal represents a system of electric generators, alternators, integrators, and motors. The system is based on common technology of inductive interactions between magnet structures and moving fluid electrolytes. Rotary impellers propel the electrolytes inside closed loop tubular tunnels in self-boosting cyclical integrating manner.

Said electromachines relate to and deal with:

fluid, mostly liquid, electroconductors,

electric and permanent magnet devices,

closed fluidynamic tunnels,

regular electric and mechanical infrastructures.

Conventional electromachines use mostly solid conductors for inductive operations. The efficiency of said electromachines can be substantially increased with electrolytic fluid conductors driven in self-boosting energy-integrating manner.

The subject matter of the present proposal is an effective electroinductive technology comprising:

fluid electrolytes driven inside closed-loop tunnels by rotary impellers;

various magnet structures, rotary and static;

combined arrangements and applications, all with high energy ratios;

regular infrastructures and auxiliaries.

The principles of this proposal are based upon some prior aspects of:
a) U.S. patent application Ser. No. 11/399,661 entitled “Hydrodynamic closed loop turbo-set self-booster” developed by present author and filed Apr. 7, 2006, in US PTO; said turboset is a power unit designed on self-accumulating technology with constant operative liquid driving turbogenerators;
b) conventional fluidynamic testing closed wind- and water-tunnels with their well-known high energy ratios up to 9.0.
c) laws of physics developed by M. Faraday, J. Henry, Biot-Savart, and H. Lenz related to magneto-electric-inductive interactions including force lines mutual interdependence and orientation.

Many of the conventional solutions related to inductive electromachines are described in classes 310, 320, 322, 324, 307, 361, 335 of the USA patent classification. However, direct prior arts, which propose inductive interactions between magnet structures and fluid electrolytes driven in closed tunnels in self-boosting manner with high-energy ratios, were not found.

### BRIEF SUMMARY OF THE INVENTION

The objects, solutions developed, and substance of this proposal are:
providing an effective, versatile source of electric or mechanical power based on electromagnetic induction of electrolytes constantly propelled inside closed-loop tunnels;
developing self-boosting technology based on a rotary impeller driving the electrolyte and operating cyclically, in actual series with itself, at itself, and for itself thus providing a high-potential electrolyte flow in an energy-integrating manner;
providing effective controlled inductance and power ratios about 2.3 for proposed electric machines alternators, generators, integrators, and motors.

This proposal illustrates wide possibilities of electrolytodynamic closed-loop technology in various self-boosting versions and comprises:
rotor-magnetic, combined, cascade, rotor-free voltage sets including generators, alternators, integrators-all with maximum magnet-flux-changings;
torque- and speed-accented motors;
AC and DC electric schemes;
Liquid and gaseous electrolytes, including seeded and mixed, respectively;
Effective anticavitation control for liquid electrolytodynamic tunnels;
Cooling fan devices for high potential electrolyte flows;
Electric and permanent magnet devices;
Regular electromechanical infrastructures and auxiliaries, including heating insulation for cold winter conditions.

### DRAWING FIGURES

The drawings are schematic, scaleless and simplified for better clarity of solutions developed. The well-known regular elements of mechanical and electrical infrastructures like couples, pulleys, gears, switches, relays, etc., are not shown as obvious.

In the drawings, closely related sets, units, and elements have the same numbers but different alphabetic suffixes.

Numbers of views and sections accord to the numbers of figures where they are shown.

FIG. 1 illustrates a front view of a monotunnel rotor set as a basic voltage generator.

FIG. 2 is a partial cross-section taken in FIG. 1.

FIG. 3 is a cross-section view taken in FIG. 2.

FIG. 4 shows a vertical cross-section-side view taken in FIG. 1.

FIG. 5 illustrates voltage-load currents graph-curves for voltage set in comparison with a conventional generator of equal input power.

FIG. 6 illustrates a scanned functional and electromechanical diagram-scheme of an examplary combined embodiments of set-self-boosting cascade structures,

FIG. 7 is a partial cross-section taken in FIG. 6.

FIG. 8 shows a front view of the combined version including hydrodynamic turbine and electromagneto-inductive set-self-booster designed operating on common closed-loop electrolyte tunnel.

FIG. 9 is a partial cross-section taken in FIG. 8.

FIG. 10 illustrates a cross-sectional view similar to that shown in FIG. 4 but for double-tunnel version of said set, with radial electromagnets.

FIG. 11 shows a cross-sectioned view taken in FIG. 6 for disk-machine version of double-tunnel set with side-placed electromagnet disk-devices.

FIGS. 12, 13, 14, 15 relate to motors.

FIG. 12 illustrates a vertical cross section-side view of a motor version related to side magnet rotor set.

FIG. 13 shows a partial cross-section of radial magnet rotor set with polyelectrode rectangular-tube tunnel unit.

FIG. 14 is an isometric partial scheme of electromagnetic force lines and fluidynamic flow interactions for voltage-set and motor versions.

FIG. 15 illustrates torque-rotor-speed graph curves for examplary motor sets in comparison with a conventional electric motor based on solid electroconductors and having the same input power in KW.

FIGS. 16, 17, 18, 19 illustrate technological schemes related to integrators.

FIG. 16 illustrates an oval integrator in scanned front view.

FIG. 17 is a cross-section taken in FIG. 16.

FIG. 18 shows a circle integrator in scanned front view scheme.

FIG. 19 is a cross-section taken in FIG. 18.

### REFERENCE NUMERALS AND SYMBOLS IN DRAWINGS

Original Units and Structures:

A) Alternators, Generators, Integrators:
20A—monotunnel rotor-set;
20B—branched monotunnel rotor set;
20C—cascade set;
20D—double-tunnel set;
20F—rotor-free set;
20IL, 20IG integrators: liquid and gaseous, respectively;
20T—turbo-inductive combined set.

B) Motors:
21S—monotunnel speed-motor;
21T—monotunnel torque-motor;

C) Common Technological Structures of Sets and Motors:
22A—closed-loop tunnel;
22C—cavitation control valve;
22E—electrode;
22H—electric tie;
22I—insert;
22L—liquid electrolyte;
22N—gaseous electrolyte;
23A—rotary pump;
23B—tunnel fan;
23D—impeller drive;
23S—impeller shaft;
24—rotor electromagnet;
24A—rotor assembly;
24B—electric brush;
24C—commutator;
24F—magnet frame;
24D—rotor drive;
24M—motor shaft;
24P—permanent magnet;
24R—radial magnet;
24S—static magnet;
24U—U-magnet;
24V—fan blade;
24X—disk magnet.

Units Related to the Prior Proposal Ser. No. 11/399,661:
30—hydrodynamic turboset self-booster;
31—oval closed-loop tunnel;
31A—bypass;
32—bispindle axial turbine;
33—turboelectric alternator.

Conventional Units, Infrastructures:
40—electric battery;
40A—charge structure;
   40R—electric rectifier;
   41—electric motor;
   42, 42A—electric transformers;
   43—cooler;
   44—wiring structure;
   44A—electro-exciting wiring;
   45—casing;
   45A—air window;
   45B—bearing;
   46—flow equalizer;
   47—heating insulation.

Symbols, Signs:
[symbol] electrolytic flow
[symbol] wiring
[symbol] voltage output
[symbol] voltage conventional output
[symbol] induced current
[symbol] set rotor rotation
SPR voltage-set power ratio
IPR integrator power ratio
T motor torque motor speed
tₑₜ, tₑᵣ—electrode steps
T_{2IS}, T_{2IT}—proposal motors' torques
T_{CSM}, T_{CTM}—conventional motors' torques
[symbol] magnetic force line
[symbol] electro-exciting wiring
V, ∇˜ voltage input
[symbol] input current
[symbol] motor power ratio
MPR motor power ratio
ω motor speed
[symbol] voltage turbo-output
   The configuration, positions, forms of magnet structures, electrodes, air gaps of inductive pairs are simplified for clarity. Scaled placements of said elements are subjects of detailed design according to magnetic fields of rotor or static magnet structures used in any definite project. Heating insulation 47 can be used for liquid electrolyte units working in cold winter conditions.

### DETAILED DESCRIPTION OF THE INVENTION

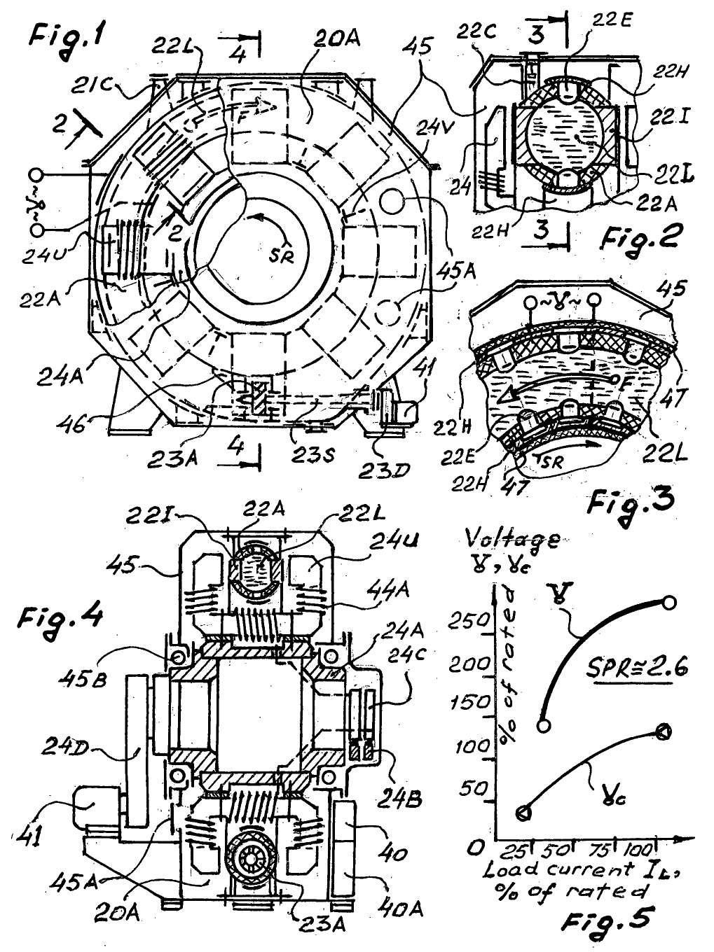

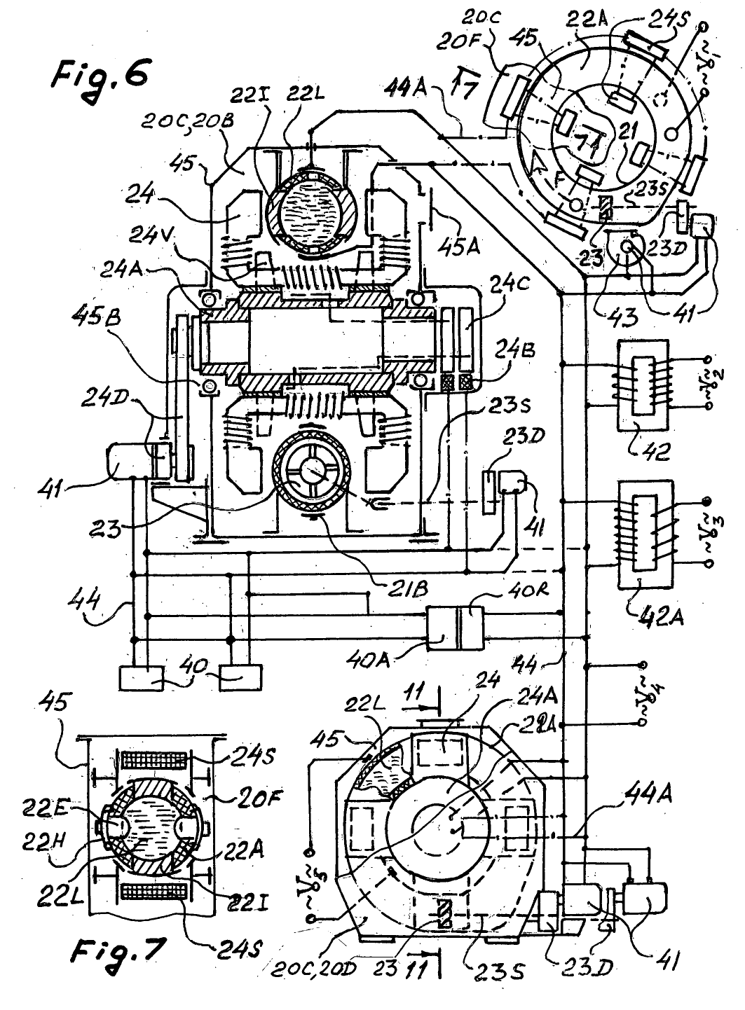

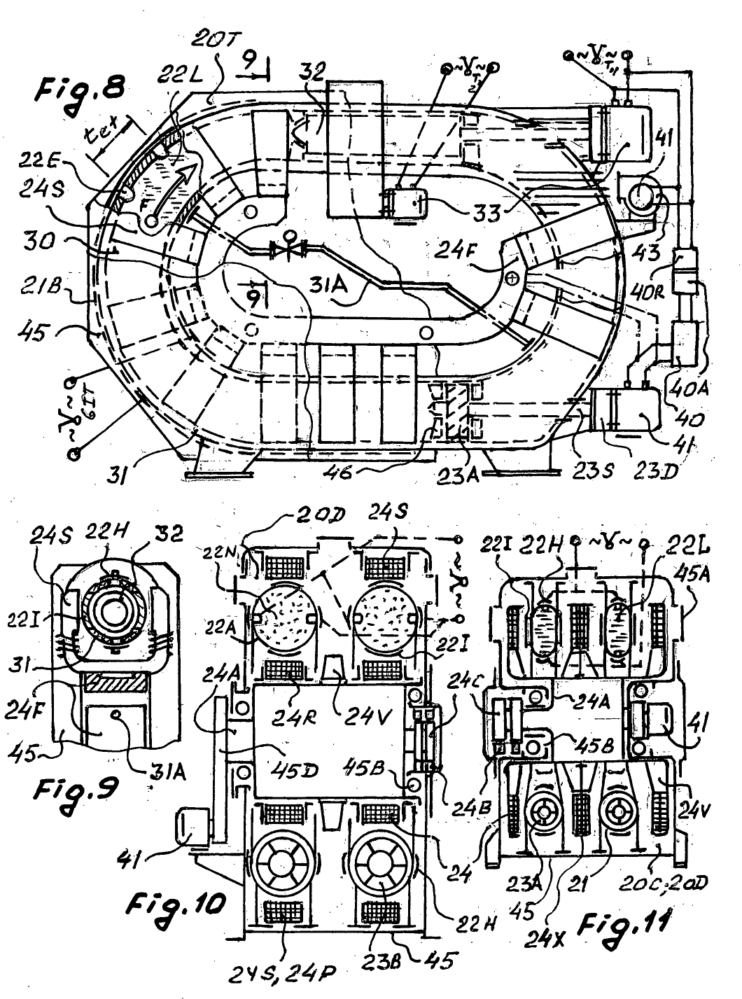

The electrolytic inductive self-boosting technology comprises a system of electric alternators, generators, integrators, and motors. Any of them include:
a) At least one closed-loop insulated tubular tunnel filled in with fluid electrolyte which is propelled by rotary impeller; electrolytes can be liquid or gaseous, and impellers are pumps or fans respectively;
b) Magnet devices which embrace said tunnel and inductively operate with moving electrolyte;
c) Electromagnetic and mechanical infrastructure.
   FIGS. 1 to 19 demonstrate a family of:
Rotor-magnetic and rotor-free, and combined voltage sets and integrators for obtaining electric power,
Rotor magnetic and combined torque-motors, and speed-motors for obtaining mechanical power.
The fluidynamic, electroinductive, and mechanical interactions among said units, their providers and infrastructures, also the graph curves-characteristics of said voltage-sets and motors are shown.

FIGS. 1, 2, 3, 4, 5 illustrate some preferred embodiments, interactions, and graph-curves of a monotunnel rotor set 20A which is developed as a liquidynamic inductive electro-alternator with rotor assembly 24A based on U-magnets 24U. Said set 20A comprises:
Closed loop insulated tubular tunnel 22A filled in with liquid electrolyte 22L which is driven by rotary pump 23A; inserts 22I;
Rotor assembly 24A with said magnets 24U. Said tunnel 22A includes electrodes 22E, electric ties 22H, and cavitation control springed valve 22C. Also are shown pump drive 23D, pump shaft 23S, flow equalizers 46, rotor drive 24D, electric batteries 40, charge structure 40A, motors 41, casing 45, rotor fan blades 24V, air window 45A, commutator 24C, electric brushes 24B, eletroexciting wiring 44A, heating insulation 47, set voltage output. Opposite directions of rotor rotation SR and fluid flow F are illustrated by symbols. Inductive interactions between electrolyte flow and rotating magnets generate output voltage provided according to known M. Faraday's and J. Henry's physical laws of induction and self-induction. FIG. 5 shows graph curves voltage-load currents of the set 20A and conventional alternator for equal input power. The averaged voltage power ratio SPR=2.6 is riced for regimes of full load.

FIGS. 6, 7 illustrate usage of monotunnel rotor-set as a basic branched set 20B for cascade set-system 20C, which also includes:
Double tunnel set 20D,
Rotor-free set 20F with its own tunnel 22A with inserts 201,
Electrolyte 22L, electrodes 22E, ties 22H, radially placed static electromagnets 24S,
Transformers 42, 42A,
Electromechanical infrastructure.
   The scanned electrotechnological and mechanical scheme shows how several sets are arranged into united combined system. This system 20C generates voltage for several outputs [symbol] and electric power for self-providing through said electromechanical infrastructure.
   Additionally are shown wiring structure 44, rectifier 40R, static electromagnets 24S for rotor-free set 20F, cooler 43.

FIGS. 8 and 9 illustrate the turbo-inductive combined set 20T based on integrated usage of prior proposal “Hydrodynamic closed loop turboset-self-booster 30” filed Jul. 7, 2006, in the united structure. The oval closed-loop tunnel 31 with inserts 221 is filled with liquid electrolyte 22L driven by axial rotary pump 23A.

The bispindle axial turbine 32 drives two turboelectric alternators 33 which generate output voltages [symbol] and [symbol] . The static electric magnets 24S, interacting with moving electrolyte 22L, induce additional output voltage [symbol] , which is taken from electrode 22E, electric tie 22H. Casing 45, bypass 31A, cooler 43, electric rectifier 40R, charge unit 40A, battery 40, electric motors 41, flow equalizer 46 are shown. The inserts 221 provide better magnetic permittivity from magnet 24S to the moving electrolyte 22L for complete inductive interactions with maximum magnet flux-penetration to the electrolyte flow.

FIG. 10 illustrates a combined version of double-tunnel set 20D including systems of rotor electromagnets 24 and static magnets 24S. Both said types of magnets arranged in radial design. Both tunnels filled-in with gaseous electrolytes 22N driven by tunnel fans 23B. The common voltage output from both tunnels is shown. The static magnets 24S can be electrical 24R and permanent 24P. Typical said earlier, elements of voltage sets are also shown in their functional interactions.

FIG. 11 shows a preferred cross-sectional design of the double-tunnel set 20D including a rotor assembly 24A based on disk magnets 24X interacting with tunnels 22A. The cross-section of said tunnels is oval for better matching to disk magnets 24X except zones of tunnel pumps 23A, where it is circular, as shown in FIG. 11. The other common elements described previously for other set versions are shown. The voltage output of this set [symbol] is common from both tunnels 22A.

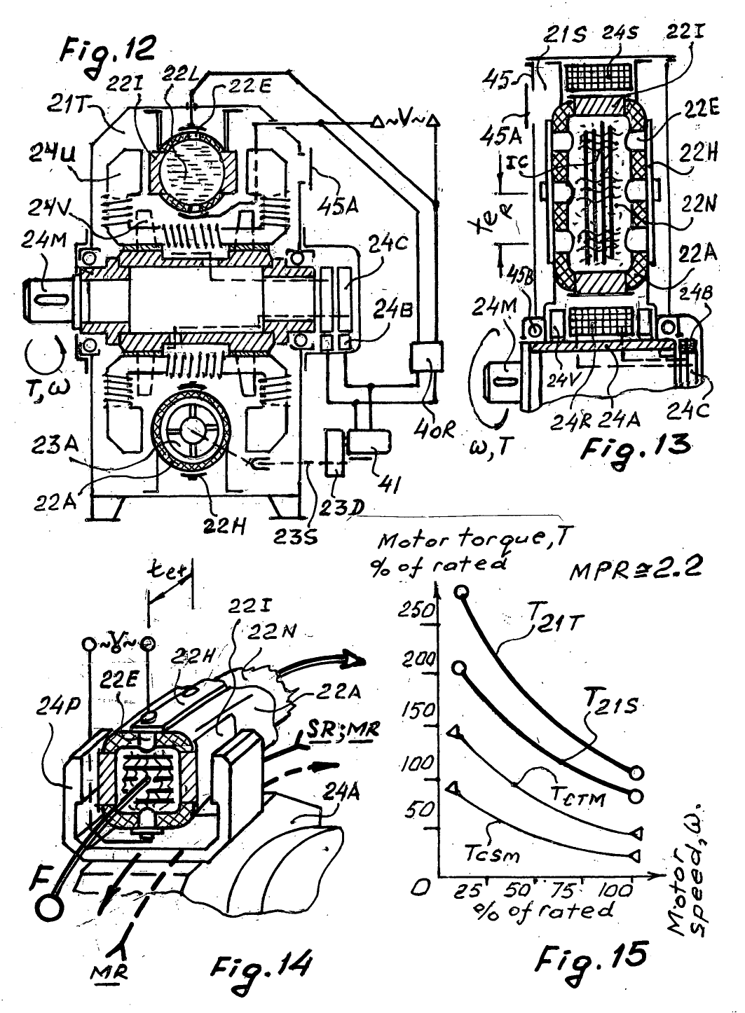

FIGS. 12, 13, 14, and 15 illustrate some preferred embodiments, interactions, and graph-curves of motor structures developed in electrolytic inductive self-boosting technology according to the present proposal.

FIG. 12 shows the monotunnel torque-motor 21T, including closed-loop tunnel 22A filled in with liquid electrolyte 22L driven by pump 23A. The rotor assembly 24A includes magnets 24 commutator 24C, fan blades 24V, motor shaft 24M with bearings 45B, voltage input wiring structure 44; electroexciting wiring 44A; electric transformer-rectifier structure 42, 40R; brushes 24B; casing 45 with air window 45A; tunnel ties 22H with their electrodes 22E; electric motor 41, pump drive 23D and pump shaft 23S are also shown.

FIG. 13 illustrates a preferred embodiment of a monotunnel speed-motor 21S including:
A rectangular cross-section closed loop tunnel 22A with multiple electrodes 22E, wide ties 22H, filled-in with gaseous electrolyte 22R
Rotor radial magnets 24R, static magnets 24S, commutator 24C, brushes 24B, fan blades 24V.
   Casing 45 with air windows 45A, motor shaft 24M with bearings 45B, symbols of interactions are also shown.

FIG. 14 demonstrates the general technological, electric and magnetic examplary interactions in isometric partial view. Are shown: closed-loop tunnel 22A with its electrodes 22E, electric ties 22H and gaseous electrolyte 22N; permanent magnet 24P, rotor assembly 24A; electrolytic flow F with according rotor rotations SR for voltage sets, SR and MR for motors depending on design and torque-speed relations and levels.

FIG. 15 illustrates torque-speed graph-curves of an examplary motor shaft 24M related to the torque-motor 21T and speed-motor 21S versions in comparison with curves of similar conventional electric motors based on high-torque and high-speed designs respectively; the input electric power is equal for all shown motors' curves. The averaged motor power ratio MPR is shown.

FIGS. 16, 17, 18, 19 illustrate some preferred embodiments and fluidynamic-electro-magnetic interactions of integrators 20IL and 20IG; said integrators are independent rotor-free voltage sets based on liquid and gaseous electrolytes 22L, 22N respectively. Some prior said elements are shown.

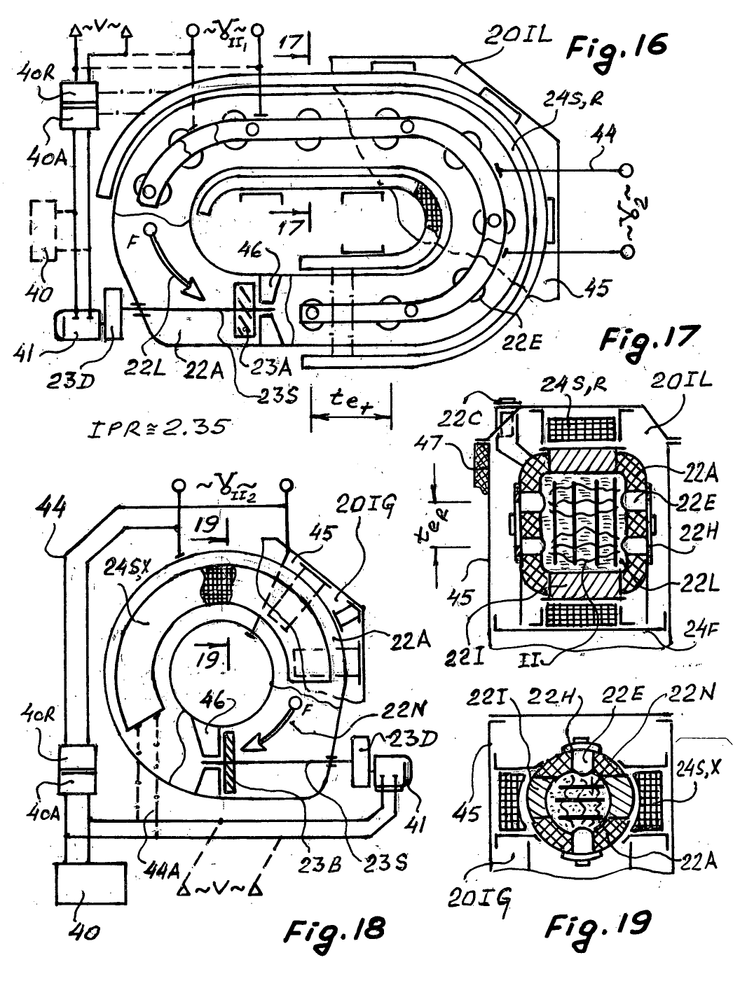

FIG. 16 shows an oval integrator 20IL with static radial magnets 24S, in scanned scheme. The possibility of feeding from electric battery 40 is illustrated.
FIG. 17 illustrates electromagnetic interactions with liquid electrolytic flow in examplary square-cross-sectional closed-loop tunnel 22A. Possible heating insulations 47 is also shown.
FIG. 18 shows a circle integrator 201G with static disk magnets 24S, in a scanned scheme. The possibility of feeding from other source of input power is shown V.

FIG. 19 illustrates electromagnetic interactions with gaseous electrolytic flow in examplary round-cross-sectional closed-loop tunnel 22A.

The average power ratio of integrators IPR 2.35.

### Operation

The technological interactions of electrolytic fluidynamic flows, magnetic force lines and electric currents are based on self-boosting work of impellers inside any of closed loop tunnels providing the present energy-integrating technology.

Common actions of technology for voltage sets and motors:
a) The rotary impellers 23A or 23B propel the electrolytes 22L or 22N respectively, inside closed-loop tunnels 22A, 31;
b) Any of said impellers operate in actual series with itself, working at itself and for itself thus forming high potential electrolytic flow inside closed-loop tunnels with energy ratio from 6 to 10 in their stable cyclical runs, and providing self-boosting operation in energy integrating manner;
c) Possible cavitation of liquid electrolytes is limited by adjustable piston-springed control valve 22C;
d) The electric and/or permanent magnets 24, 24P, 24R, 24S, 24U, 24X, excited and supported by batteries 40 and/or wirings 40, 40A in various schemes, provide magnetic flux
e) Said flux effectively penetrates through insulated but with high magnetic permeability tunnel's inserts 221, electromagnetically acts with propelled electrolytes thus inducing electric current.

Voltage Sets' and Integrators' Specifics:
a) The output voltage

$$= - \frac{d φ}{d t} ,$$

according to M Faraday's law;
Maximum leve of the magnetic flux changing

$$\frac{d φ}{d t}$$

is provided by:
opposite directions of magnetorotors rotations and electrolyte flows inside tunnels, and
electrolyte flows and static magnets in rotor-free and turbo-inductive sets
b) Said magnetic flux changings induce the electric current in running electrolytes 22L, 22N; electrodes 22E and connected to them electric ties 22H feed the induced voltage [symbol] to the load system
c) The load system can feed any structures including other sets in cascade schemes, transformers, own electric motors, rectifiers, charge devices, and others depending on design
d) The average voltage set output power ratio for said voltage sets-generators, integrators, alternators [symbol] where [symbol] is a sum of set output power (voltage×current) kw, is a sum of set input voltage×current, kw SPR=2.4 to 2.7 ; so

$${SPR}_{av} = \frac{\sum \times {I}_{S}}{\sum {V}_{I} \times {I}_{I}} ≅ 2.6 .$$

Motor specifics:
a) the torque T on any motor shaft 24M is

$$T = \frac{d W}{d ω} = {K}_{t} \times φ \times {I}_{V} ,$$

where -energy of rotor air gap; speed of shaft rotation; Kₜ-coefficient; magnetic flux; Iᵥ-current from voltage input V.
b) said currents Iᵥ, fed into running electrolytes 22L, 22N through ties 22H and electrodes 22E, induce electromagnetic fields which, interacting with magnetic fields of rotor magnets, caused motor rotor to rotate providing for motor shaft needed torque T and speed
c) adjustable and reversible electrolyte flows can provide needed performance of motors' torque-speed characteristics.
d) The average motor output power ratio

$$MPR = \frac{\sum T \times ω}{\sum {V}_{I} \times {I}_{I}} ,$$

where is a sum of various motors' output torque×speed, is a sum of motors' input power in according units. MPR_{aV}=2.1 to 2.3.

The main factors of the present technology effectiveness:
a) The power of electrolyte impellers is about 9 times less than energy level of electrolytes moving in tunnels due to integrating self-boosting closed-loop operating;
b) Electroconductivity and magnetic permittivity of high potential electrolytic flows is higher and better for electromagnetic inductance;
c) Real relative speeds of moving subjects of the magneto-inductive process are bigger because of proper directions, providing maximum magnetic flux changings
d) Mutual dispositions of magnet structures and electrolytodynamic tunnels with their electrodes, inserts, insulations accord to known laws of Biot-Savart and H. Lenz related to directions for magneto-electric-inductive interactions.
   The indicated power ratios for voltage sets and motors are provided by self-boosting technology of fluid electrolytes propelled in closed loop tunnels with high fluid pressure ratios in energy integrating manner. Said power ratios are actual efficiency levels of the present technology.

1. An electrolytic inductive self-boosting technology for basic power converting in electric generators, alternators, integrators, and motors, comprises:
a. At least one closed-loop insulated tubular tunnel filled-in with fluid electrolyte which is propelled by rotary impeller, and
b. Magnet devices which embrace said tunnel and inductively operate with said moving electrolytes, thus providing voltage output in generators, alternators, integrators, and providing torque-speed output in motors.

2. The technology of claim 1 includes usage of liquid electrolyte solutions and gaseous mixtures driven in their tunnels by rotary hydraulic pumps and fans respectively, as fluid flow impellers.

3. The fluid electrolytes of claim can be seeded and compounded for better inductance and conductivity.

4. The technology of claim 1, wherein said electric machines are based on alternating and direct electric current systems

5. The technology of claim 1, wherein said magnet devices are from the group consisting of electric, permanent, and both kinds of magnets.

6. The magnets of claim 5, depending on design, can be arranged in following embodiments:
a. Side and disk magnet devices,
b. Radial magnets,
c. Rotary versions for any structures,
d. Static versions for integrators, and rotor-free generators,
e. Combined versions depending on task and design.

7. The electrolytic inductive technology of electric machines for power converting in dynamic self-boosting and cyclical integrative manner, includes at least one rotary impeller, which drives fluid electrolyte inside closed-loop tubular insulated tunnel, and works in actual series with itself, for itself, and itself whereby forming high potential fluid flow for electroinductive interactions with magnet devices through tunnels' inserts.

8. The technology of claim 7 wherein said closed-loop tubular insulated tunnel includes orientated metallic inserts, electrodes, electric ties, and wirings for effective magnetic and electric interactions.

9. The technology of claim 7 wherein said tunnels can have circular, elliptical, and any kind of rectangular cross-sections in zones of magnets with multiple electrodes, inserts, with orientations in order to provide the inductance according to designed magnet devices.

10. The tunnels of claim 7 have preferably circle and oval general contours with widening segments for electrolyte impellers according designs.

11. The tunnels' inserts of claim 7 and electrodes of claim 8 include metallic materials with high magnetic and electric permitivities and conductivities respectively for providing effective penetration of magnetic fluxes and electric currents in inductive interactions.

12. The technology of claim 7 wherein said tunnels include a springed-piston valve to limit and control possible cavitation for liquid electrolyte versions.

13. The technology of claim 7, wherein said electrolytic fluid flows are propelled by said impellers in directions which are opposite to rotating magnet structures of generators, integrators, and alternators for maximum magnetic flux changes.

14. The technology of claim 7, wherein said electrolytic fluid flows are propelled by said impellers in directions which are opposite to rotating magnet structures of torque-motors and the same way to rotating magnet structures for speed-motors, according to design tasks.

15. The technology of claim 7 comprises combined tunnel systems including cascade schemes, multitunnel units, turboset-self-boosters with needed conventional devices: coolers, electric batteries, chargers, rectifiers, regular electric motors, drives, commutators, wirings, switches, relays, valves, electromechanical infrastructures—all said elements and units to provide usual common support for the claimed technology.
